(19) United States
(12) Patent Application Publication
(10) Pub. No.: US 2008/0176462 A1
(43) Pub. Date: Jul. 24, 2008

(54) Electrical connector having terminating module

(75) Inventors: Zhi-Jian Liu, Kunshan (CN); Zheng-Hua Xu, Kunshan (CN); Li-Chun Wu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/009,495

(22) Filed: Jan. 18, 2008

(30) Foreign Application Priority Data
Jan. 19, 2007 (CN) 200720033658.8

(51) Int. Cl. H01R 9/24

(52) U.S. Cl. 439/884

(57) ABSTRACT

An electrical connector having a terminal module (1) engaging with a mating plug. The terminal module has a number of terminals (3) for electrically connecting with the mating plug and a base portion (2) having a first planar portion (23). The first planar portion includes two arrays of protrusions (21) parallel with each other, a receiving space (20) defined between the two arrays of protrusions and a number of recesses (200) each formed between two adjacent protrusions and communicating with the receiving space. The protrusion has a pair of side faces (221) each having a rib (211) formed thereon for engaging with the terminals.

### BACKGROUND OF THE INVENTION

1. Field of the Invention

The present invention relates to an electrical connector having a terminal module, and more particularly, relates to a terminal module having an improved base portion for retaining corresponding terminals.

2. Description of the Prior Art

A conventional terminal module mounted to an electrical connector is disclosed in U.S. Pat. No. 6,764,343 issued on Jul. 20, 2004. The terminal module has a substrate, an electrical circuit board mounted to the substrate and a plurality of terminals. The substrate has a first planar portion, a second planar portion extending parallel to and offsetting from the first planar portion. The first planar portion is formed with a plurality of generally parallelly extending elongate recesses for seating the terminals.

However, the conventional terminal module does not firmly receive the terminal inserted into the recess. The interference fit between the terminal and recess does not provide enough retaining force for fastening the terminals.

Hence, an improved electrical connector is needed to solve the above problem.

### BRIEF SUMMARY OF THE INVENTION

One object of the present invention is to provide a terminal module having an improved base portion for engaging with a plurality of terminals.

The present invention provides an electrical connector having a terminal module electrically connecting with a mating plug. The terminal module comprises a plurality of terminals having an elongate portion and a contacting portion bending from the elongate portion, and a base portion having a first planar portion. The elongate portion comprises a front tab, a rear tab received in corresponding recesses and a projection. The base portion has two arrays of protrusions paralleled with each other, a receiving space defined between the two arrays of protrusions and a plurality of recesses each formed between the two adjacent protrusions and communicating with the receiving space. The protrusion comprises a pair of side faces each having a rib disposed thereon for engaging with the terminals.

Advantages of the present invention are to provide a pair of ribs disposed on the side faces of the protrusion. The front and rear tabs of the elongate portion upwardly resist against the ribs for fastening the terminal and the projection engages with the rear face of the protrusion for fixing the terminal. It is easy to firmly fix the terminals in the recesses and therefore hard to loosen the terminals from the recesses.

Other objects, advantages and novel features of the invention will become more apparent from the following detailed description of the present embodiments when taken in conjunction with the accompanying drawings.

### BRIEF DESCRIPTION OF THE DRAWINGS

FIG. 1 is an assembled perspective view of a terminal module according to the present invention;

FIG. 2 is a perspective view of a plurality of terminals mounted to a first planer portion of the terminal module;

FIG. 3 is an exploded view of the terminals and the first planer portion of FIG. 2;

FIG. 4 is a magnifying view of protrusions of the first planer portion, as especially labeled in FIG. 3; and

FIG. 5 is another exploded view similar to FIG. 3, taken from another aspect.

### DETAILED DESCRIPTION OF THE INVENTION

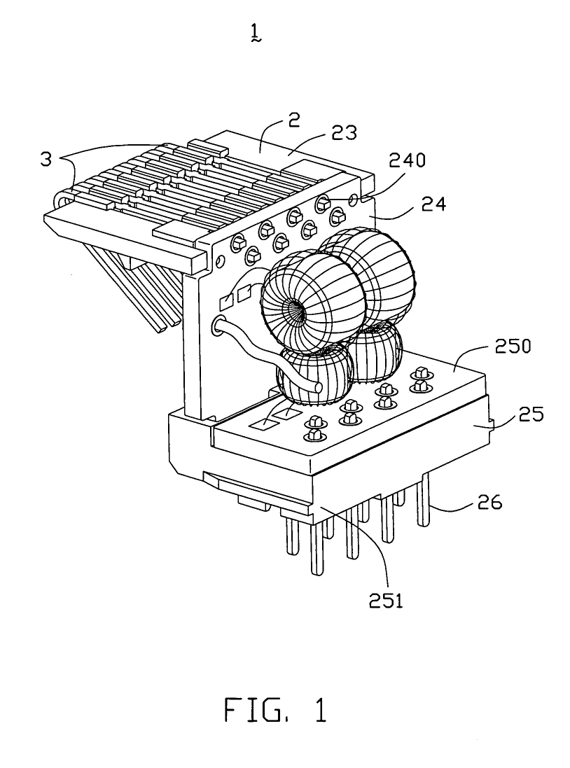

Reference will now be made to the drawing figures to describe the present invention in detail. Referring to FIG. 1, a terminal module 1 mounted to an electrical connector (not shown) in accordance with the present invention comprises a base portion 2 and a plurality of terminals 3 mounted to the base portion 2.

As shown in FIG. 1, the base portion 2 has a first planer portion 23, a first circuit board 24 perpendicular to the first planer portion 23, a second planar portion 25 extending parallel to and offsetting from the first planar portion 23, a plurality of terminals 3 mounted to the first planer portion 23 and a number of pins 26 mounted to the second planer portion 25 and electrically connected with a circuit board (not shown). The second planar portion 25 has a rectangular housing 251 and a second circuit board 250 mounted on the rectangular housing 251.

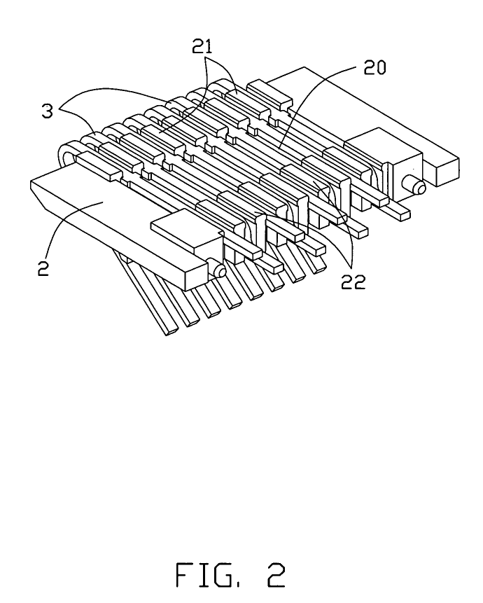

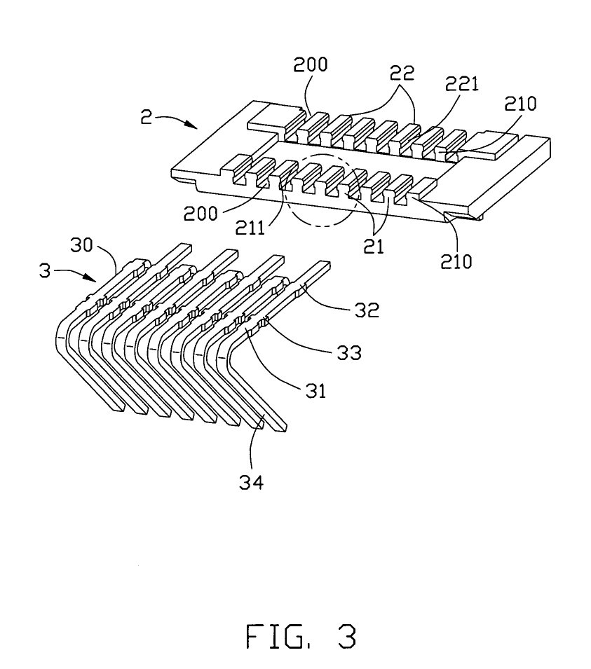

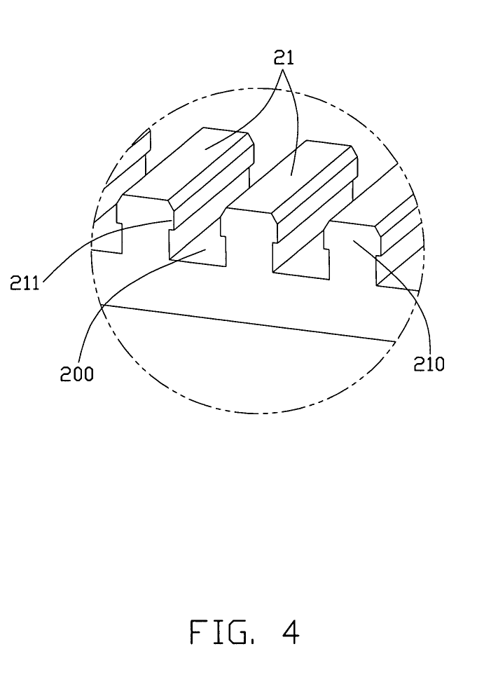

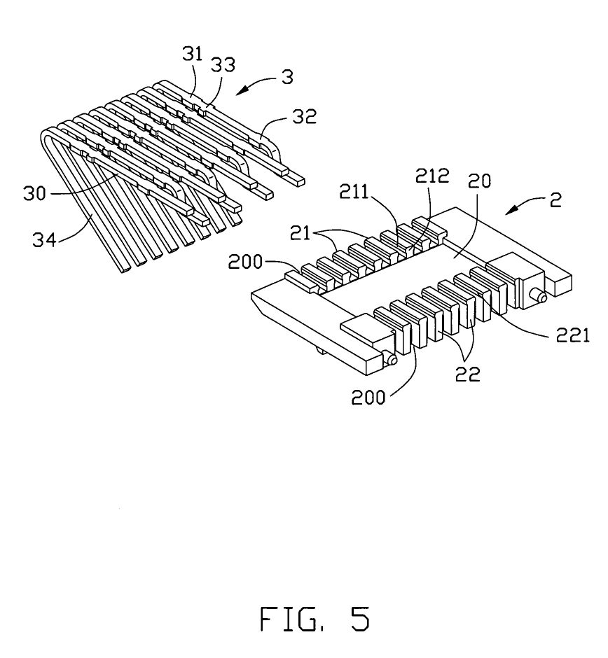

As shown in FIGS. 2-5, the first planer portion 23 has two arrays of rectangular protrusions 21, 22 parallel with each other and arranged along regular intervals lengthwise along opposite sides of top surface of the first planer portion 23, a receiving space 20 defined between the two arrays of rectangular protrusions 21, 22 and a plurality of recesses 200 each formed between two adjacent rectangular protrusions 21 or 22 and communicating with the receiving space 20. Each protrusion 21 has a pair of ribs 211 formed at opposite sides thereof for engaging with the terminals 3. The rectangular protrusion 21 has a “T” shaped front face 210, a rear face 212 opposite to the front face 210 and a pair of opposite side faces 221.

Each terminal 3 has an elongate portion 30 and a contacting portion 34 bent from the elongate portion 30. The elongate portion 30 comprises a pair of front tabs 31 and a pair of rear tabs 32 received in corresponding recesses 200 and upwardly resisting against the ribs 211 of the rectangular protrusions 21. The elongate portion 30 further includes a pair of projections 33 adjacent to the front tabs 31 for engaging with the rear faces 212 of the protrusions 21 for fixing the terminal 3.

In assembling of the terminal module 1, firstly, the terminals 3 are mounted on the top surface of the first planar portion 23 in a top-to-bottom direction. At this time, the front tabs 31 and the projections 33 are disposed in the receiving space 20, the rear tabs 32 are disposed at the outside of the rectangular protrusions 22. Secondly, the terminals 3 are pushed forwardly, then the front tabs 31 and the rear tabs 32 are respectively retained in the corresponding recesses 200 and resisting against the ribs 211 of the rectangular protrusions 21. At the same time, the projections 33 are stopped by the rear face 212 of the protrusions 21. Ends of terminals 3 extend outwardly through a plurality of holes 240 disposed on the first circuit board 24 and are soldered thereto, thus fixing the first planar portion 23 to the first circuit board 24. Finally, the first circuit board 24 engages with the second planar portion 25.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector having a terminal module for engaging with a mating plug, the terminal module comprising:
a plurality of terminals for electrically connecting with the mating plug; and
a base portion comprising a first planar portion having two arrays of protrusions, a receiving space defined between the two arrays of protrusions and a plurality of recesses each formed between every two adjacent protrusions and communicating with the receiving space, said protrusion having a pair of side faces each having a rib formed thereon, the ribs retaining the terminal to the recess.

2. The electrical connector as claimed in claim 1, wherein each terminal comprises a plurality of tabs received in corresponding recesses below said ribs.

3. The electrical connector as claimed in claim 2, wherein said tabs comprise a pair of front tabs and a pair of rear tabs received in corresponding recesses.

4. The electrical connector as claimed in claim 1, wherein said protrusion has a T-shaped front face and a T-shaped rear face opposite to the front face.

5. The electrical connector as claimed in claim 4, wherein each terminal has an elongate portion and a contacting portion extending obliquely from the elongate portion.

6. The electrical connector as claimed in claim 5, wherein said elongate portion has a pair of projections at opposite sides thereof for resisting against the rear faces of the protrusions.

7. The electrical connector as claimed in claim 1, wherein said base portion has a first circuit board perpendicular to the first planar portion, a second planar portion extending parallel to and offsetting from the first planar portion and a plurality of pins mounted to the second planar portion.

8. The electrical connector as claimed in claim 7, wherein said second planar portion has a rectangular housing and a second circuit board mounted to the rectangular housing.

9. An electrical connector comprising:
a terminal module defining a plate with a seating face thereon;
a plurality of terminals seated upon the seating face;
first and second rows of protrusions being formed on the seating face under a condition said first row and said second row are spaced from each other along a first direction, protrusions in each of said first and second rows are alternately arranged with the terminals in a second direction perpendicular to said first direction, each of said protrusions defines two outwardly extending ribs oppositely on two sides thereof along said second direction, and said ribs downwardly abuts the corresponding terminals in a third direction perpendicular to said first and second direction for retaining said terminal in position.

10. The electrical connector as claimed in claim 9, wherein each of said terminals defines two outwardly extending ribs oppositely on two sides thereof along said second direction to abuts against the corresponding protrusions aside for reinforcing retention therebetween in said second direction.
